(19) United States
(12) Patent Application Publication
(10) Pub. No.: US 2009/0033123 A1
(43) Pub. Date: Feb. 5, 2009

(54) Vehicle Glazing

(75) Inventors: Ashley Carl Torr, Lancashire (GB); Peter Paulus, Munster (DE)

Correspondence Address: BUCHANAN, INGERSOLL & ROONEY PC, POST OFFICE BOX 1404, ALEXANDRIA, VA, 22313-1404, US

(73) Assignees: Pilkington Automotive Limited, St. Helens, MERSEYSIDE (GB); Pilkington Autonotive Deutschland GmbH, Witten (DE)

(21) Appl. No.: 12/279,321

(22) PCT Filed: Jan. 30, 2007
(86) PCT No.: PCT/GB2007/050044

§ 371 Date: Sep. 8, 2008

(30) Foreign Application Priority Data
Feb. 14, 2006 (GB) 0602943.3

(51) Int. Cl. B60J 1/02; B60J 1/20; E06B 9/24

(52) U.S. Cl. 296/96.19; 52/204.5

(57) ABSTRACT

A vehicle glazing comprising a pane of body-tinted glazing material, which provides the glazing with a solar control and/or privacy function, having a capacitive moisture sensor mounted relative to it. The glazing material may be tinted glass. If the glazing is a laminate, the ply of interlayer material may be body-tinted additionally, or alternatively, to the two panes of glazing material being tinted. The sensor may include at least two sensing lines of conductive ink printed onto the glazing material. The sensing lines may additionally function as antenna and/or part of alarm circuitry and/or part of a heating element for defrosting/demisting the glazing.

The present invention relates to vehicle glazings, especially to vehicle glazings provided with a moisture sensor.

Moisture sensors are well known in combination with vehicle glazings, especially windscreens. An optical sensor, which is the most common type of moisture sensor used with a vehicle glazing, generally works on a principle based on comparison of a received signal with a reference electrical threshold signal. A transmitter emits at least one infrared signal to propagate at a particular angle (usually 45°) through for example a single ply of glazing material of a certain thickness. The signal is internally reflected by the ply of glazing material, after which it is collected by a receiver which transforms it into an electrical signal. Comparison of the transformed electrical signal with a reference signal provides information as to the presence of moisture (if any) on the opposite surface of the sheet of glazing material to which the sensor is mounted, for example the external surface of a windscreen. In response to the comparison, an action, for example operation of windscreen wipers, may result.

Such an action is desirable because it removes one potential source of distraction for the driver of a vehicle fitted with a glazing having a moisture sensor; the driver no longer has to concern himself with questions of whether or not there is moisture present on the glazing and whether or not he should, for example, activate the windscreen wipers of his vehicle, and so may have a more comfortable journey in his vehicle. In fact, vehicle manufacturers are continually searching for ways and means to increase the comfort and safety of a vehicle driver when in his vehicle. Vehicle glazings may possess solar control properties to increase thermal comfort, privacy features to reduce visibility into a vehicle from the outside, acoustic control properties to increase aural comfort, to name but a few.

Insofar as vehicle glazings may have solar control and privacy properties, backlights (rear window glazings), the top halves of split level bus windscreens, rooflights (roof glazings which may extend over substantially the whole or a part of the roof of a vehicle) and rear sidelights (rear side window glazings) in particular, which are not constrained by the at least 70% visible light transmission (measured with CIE Illuminant A) legal requirements of the USA and Europe, may be made of body-tinted glass, or may be body-tinted laminates, having a visible light transmittance of less than 70%.

Unfortunately, such body-tinted glazings are often incompatible with currently available optical moisture sensors because, as described above, such sensors rely on the ability of the glazing to transmit and receive undistorted electromagnetic signals. A tinted glazing is intrinsically less capable of transmitting radiation compared to a clear glazing because of absorption of radiation of various wavelengths in varying amounts.

It would nonetheless be desirable to provide a vehicle glazing which increases driver comfort and safety as much as possible, especially by provision of a glazing having a moisture sensor as well as solar control and/or privacy properties.

Accordingly, the present invention provides a vehicle glazing comprising:

a pane of glazing material, and
a moisture sensor mounted relative to said pane,
wherein the pane of glazing material is body-tinted, thereby providing the glazing with a solar control and/or a privacy function, and the moisture sensor is a capacitive sensor.

Preferably the body-tinted pane of glazing material is a pane of glass comprising at least 0.4% by weight total iron (expressed as Fe₂O₃). As an upper limit, it is believed that 3.0% total iron is sufficient to achieve the desired solar control and/or privacy properties of a glazing. However, 0.45 to 2.0% total iron is further preferred, and 0.5 to 1.8% total iron is most preferred, to achieve an optimum balance between the desired properties and visible light transmittance of the glazing.

In addition to an amount of total iron as a colourant, the pane of glass may further comprise one or more of the following additional colourants: cobalt oxide, selenium, chromium oxide, titanium oxide, manganese oxide, copper oxide, vanadium oxide, nickel oxide. Specifically, if cobalt oxide (expressed as CO₃O₄) is present as a colourant, it may be included in an amount greater than 40 ppm and up to around 500 ppm, more preferably in the range from 45 to 300 ppm and most preferably in the range from 50 to 250 ppm. Moreover, if selenium (expressed as Se) is present as a colourant, it may be included in an amount up to 30 ppm, more preferably in the range from 2 to 25 ppm and most preferably in the range from 5 to 20 ppm. In total, these additional colourants may be present in an amount up to 0.2% by weight of the glass.

In addition to being body-tinted, the pane of glass may be toughened. The pane of glazing material may alternatively be made from a rigid plastics material, such as a tinted polycarbonate. The pane of glazing material may be flat or it may be curved. A pane may be between 0.5 and 25 mm in thickness, preferably between 1 and 10 mm, further preferably between 1 and 5 mm. The thinner the pane of glazing material, the lighter in weight the glazing will be, which is advantageous for vehicle manufacturers and the environment generally because a vehicle equipped with lighter-weight glazings is usually more fuel efficient as a result of its overall weight reduction.

Furthermore, the pane of body-tinted glass may form part of a laminate (as either the inner or the outer pane) along with a further pane of glass which may be clear or body-tinted (having the same or a different tint to the first pane). The laminate may include a clear interlayer material such as polyvinyl butyral (“PVB”) between the two plies of glass, or it may be body-tinted and/or solar absorbing and/or have sound insulation properties. Alternatively it may be that the laminate is tinted solely by the presence of a body-tinted interlayer material (between two panes of clear glass or plastics material), in which case the moisture sensor would be mounted relative to one of the surfaces of the laminate. The moisture sensor would preferably be mounted on the innermost surface of the laminate (i.e. the outer surface of the inner pane).

As a result of having the pane of glazing material or the laminate overall body-tinted (as the case may be), it may be that the energy transmission of the glazing over the wavelength range 800 to 950 nm is less than around 20%, and less than around 15% in the 870 to 890 nm range. The former wavelength range corresponds to the near infrared region of the electromagnetic spectrum. In this region, the sensitivity of many optical moisture sensors drops by such an appreciable amount as to severely limit their operational benefit, rendering some effectively useless. It is however possible to provide such a glazing with a fully functioning, highly sensitive moisture sensor in the form of a capacitive sensor, which is capable of detecting the presence of moisture on a surface of the glazing irrespective of the transmission of that glazing.

A pane of glazing material may be described as having an inner surface and an outer surface. In conventional vehicle glazing surface numbering terminology, the surfaces of a pane of a glazing are consecutively numbered inwardly from the surface that contacts the environment on the exterior of a vehicle to the surface that contacts the environment inside the vehicle. Thus for a single pane of glazing material, the surfaces are numbered one (being the outer surface) and two (being the inner surface), and for a laminate glazing surface one is the outermost surface and surface four is the innermost surface.

A number of capacitive moisture sensors are known in the art for use with a vehicle windscreen (having a visible light transmittance of at least 70%); for a single pane glazing, a sensor may detect moisture on surface one and/or surface two, whilst for a laminate, a sensor may preferably detect moisture on surface one. Any of these sensors may be used in the vehicle glazing of the present invention. It is however preferred that the sensor comprises at least two separate sensing lines of conductive ink printed onto surface two of the glazing (when monolithic) and on either surface two, three or four, preferably four, of the glazing (when laminated). The conductive ink used is preferably a silver-based ink which can be screen-printed onto a pane and subsequently fired in known manner. Typically, the sensing lines may be printed onto an area of the surface of the glazing that corresponds to an area on surface one of the glazing arranged to be wiped by wiper blades (in this case, moisture may be detected on surface one of the glazing). Having the sensing lines in this area means that the sensor can accurately respond to a changing moisture level each time the outer surface of the glazing is wiped by the wiper blades.

Advantageously, at least one of the sensing lines may further function as an antenna and/or part of alarm circuitry. When also functioning as an antenna, a sensing line may be designed to have a size, shape and configuration to receive and transmit electromagnetic radiation for the following applications: a mobile telephone, a global positioning system (“GPS”), television, radio (AM, FM, digital), and the like. To function as an antenna a sensing line must be connectable by a suitable connection means (for example a co-axial cable) to the device in question (mobile phone, radio, etc.). Other electronic components such as an amplifier may be connectable between the antenna element and the device. Alarm circuitry is known in the art and generally includes alarm-activating electronics, a current source to provide electrical current to flow around the alarm circuit and an alarm output (for example, a horn, flashing light, etc.). The design of a sensing line is preferably such that it covers a significant portion of the glazing, thus a breakage substantially anywhere in the glazing may trigger the alarm (once the glazing has been suitably connected into the alarm circuitry).

Further advantageously, the glazing may be provided with a heating element, and the sensing lines may be located outboard of the heating element. By “heating element” is meant a device which performs the function of de-icing and de-misting a glazing as and when required. The heating element typically comprises a plurality of spaced apart, fine heating lines. The heating lines usually extend over the area of the glazing that is to be de-iced and de-misted, and this area may correspond to substantially the entire area of the glazing itself. Preferably the heating lines are black in colour, to minimise their appearance in the glazing; the black colouration may be achieved by oxidation of the lines themselves. To perform their heating function, the heating lines ordinarily require a supply of electrical energy so that they may resistively heat the glazing. Normally a pair of busbars is provided to supply an electric current to the heating lines. The busbars normally exist independently of the heating lines and may be made from, for example, tinned copper strips or silver prints, as is known. By stating that the sensing lines may be located “outboard” of the heating element is meant that the sensing lines may be located in the peripheral region between the outer extremity of the heating element and the edges of the glazing. When measuring the impedance between two or more sensing lines, it is preferable that no other conductor be in close proximity to (i.e. be within 20 mm of) the lines, to avoid any unwanted coupling effects. However, it is still possible that the sensing lines may be located between any two of the heating lines in the heating element. Furthermore it is possible that one or more of the heating lines of the heating element may also function as a sensing line of the capacitive sensor.

The at least two sensing lines comprised in the capacitive moisture sensor may be arranged on the inner(most) surface of the glazing such that the sensor is able to distinguish between moisture detected on each of the outer(most) and inner(most) surfaces of the pane. There are known capacitive moisture sensors that are able to perform such dual-detection, and the principle of operation of such sensors may be applied to the present invention. One such dual-detection sensor is described in, for example, international patent publication WO 01/81931. Advantageously, the capacitive moisture sensor comprised in the glazing of the invention includes activation electronics that is arranged to activate a) wiper blades when moisture is detected on the outer(most) surface of the glazing, and/or b) the heating element when moisture is detected on the inner(most) surface of the glazing. The activation electronics is preferably housed within a unit mounted relative to the inner(most) surface of the glazing. Having the activation electronics housed in this manner is beneficial because it means that the glazing, with the circuitry needed to control one or both of the sensor and the heating element, may be supplied as a complete unit to vehicle manufacturers ready for simple installation into, by connection of the circuitry to the power supply of, a vehicle. This benefit may be extended if the glazing is provided with an antenna and/or alarm circuitry, whether or not in the form of a sensing line as described above, and the unit also houses the additional electronics that is needed to regulate the function of one or both of these additional elements. Moreover, the unit which houses the activation electronics (and any further additional electronics) may be the same unit that houses a high mounted stop lamp (“HMSL”—also known as a third brake lamp), thereby reducing the number of additional elements to be added to a glazing, making its production simpler.

A vehicle glazing according to the invention may be fitted into any window opening in the bodywork of a vehicle that is not subject to the visible light transmittance requirements mentioned earlier. However, it may be especially used as a backlight and/or a rooflight.

For a better understanding the present invention will now be more particularly described by way of non-limiting example with reference to, and as shown in, the accompanying schematic drawings wherein:

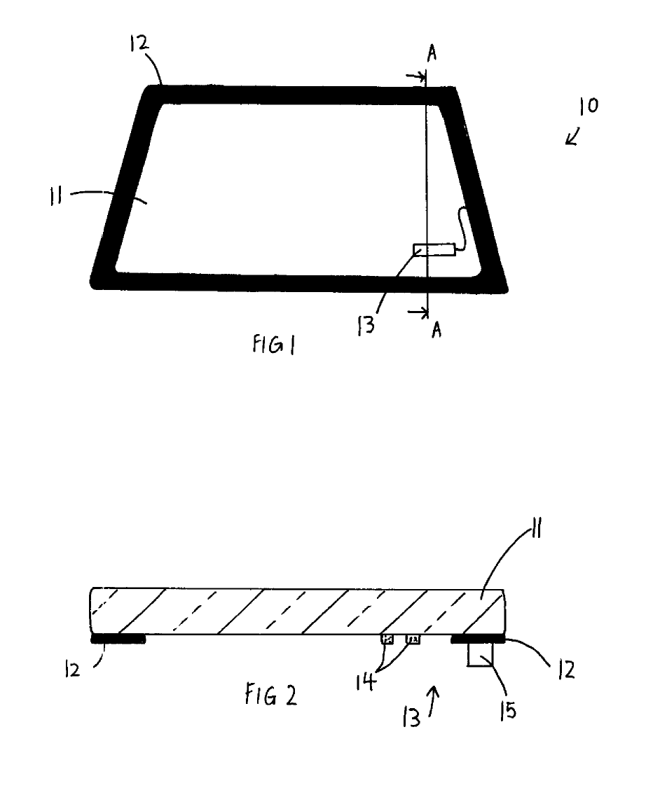

FIG. 1 is a perspective view of a vehicle glazing according to the invention; and

FIG. 2 is a cross section viewed along line A-A of FIG. 1.

Vehicle glazing 10 of FIG. 1 comprises pane of glazing material 11, in the form of a pane of toughened soda lime silica glass backlight, capacitive moisture sensor 13 mounted on a surface of pane 11 and obscuration band 12 around the periphery of pane 11 to disguise and protect the sealant (not shown) that may be used to fix the window into a vehicle (not shown). An obscuration band is usually made from opaque ink that is screen printed onto a surface of a pane of glazing material and subsequently fired. Sensor 13 is located in the vision area of pane 11 (i.e. the area not obscured by obscuration band 12) which is also the area that may be wiped by the wiper blades of a vehicle into which glazing 10 may be installed.

FIG. 2 provides more detail about the construction of glazing 10 in that obscuration band 12 is provided on the inner surface (surface 2) of pane 11. Furthermore sensor 13 is also mounted on the inner surface of pane 11. Sensor 13 comprises a pair of sensing lines 14, in the form of strips of silver-containing ink printed onto the inner surface of pane 11, which are in electrical communication (for example, via more silver print) with activation electronics 15, in the form of wiper control electronics. Activation electronics 15 is provided in a unit which is mounted, for example via a spring contact, on silver print that merges with sensing lines 14, in the region of obscuration band 12 so as not to be visible from outside of the vehicle.

Pane of glass 11 may be a 4.85 mm pane tinted glass having for example one of the following compositions:

### Composition 1

Base glass (by weight): 72.1% SiO₂, 1.1% Al₂O₃, 13.5% Na₂O, 0.6% K₂O, 8.5% CaO, 3.9% MgO and 0.2% SO₃, and a colourant portion (by weight): 1.45% total iron (calculated as Fe₂O₃), 0.30% ferrous oxide (calculated as FeO), 230 ppm CO₃O₄, 210 ppm NiO and 19 ppm Se. Such a glass is currently available as GALAXSEE™ from Pilkington Group Limited in the United Kingdom;

### Composition 2

Approximately the same base glass as for composition 1, and a colourant portion (by weight): 1.57% total iron (calculated as Fe₂O₃), 0.31% ferrous oxide (calculated as FeO), 115 ppm CO₃O₄, 0 ppm NiO and 5 ppm Se. Such a glass is currently available as SUNDYM™ again from Pilkington Group Limited.

Inner surface of pane 11 could additionally be provided with a heating element, and sensing lines 14 could have multiple functionality, as described above.

Furthermore, pane of glass 11 may form part of a laminate (as either the inner or the outer pane) along with a further pane of glass and a ply of interlayer material. Such a laminate, for example combining two plies of glass of composition 2 at 3.15 mm thickness with a 0.76 mm thick ply of clear PVB, may be especially useful as the top half of a split-level bus windscreen, as discussed earlier.

1-15. (canceled)

16. A monolithic vehicle glazing comprising:
a body-tinted pane of glazing material, which provides the glazing with a solar control and/or a privacy function, and which has an inner surface and an outer surface; and
a capacitive moisture sensor, comprising at least two separate sensing lines, mounted on the inner surface of the pane.

17. A vehicle glazing as claimed in claim 16, wherein the body-tinted pane of glazing material is a pane of glass comprising at least 0.4% total iron (expressed as Fe₂O₃).

18. A vehicle glazing as claimed in claim 17, wherein the pane of glass further comprises one or more of the following additional colourants: cobalt oxide, selenium, chromium oxide, titanium oxide, manganese oxide, copper oxide, vanadium oxide, nickel oxide.

19. A vehicle glazing as claimed in claim 16, wherein the energy transmission of the pane of glazing material over the wavelength range 800 to 950 nm is less than 20%.

20. A vehicle glazing as claimed in claim 16, wherein the at least two separate sensing lines are of conductive ink printed onto the inner surface of the pane.

21. A vehicle glazing as claimed in claim 20, wherein the sensing lines are printed onto an area of the inner surface of the pane of glazing material that corresponds to an area on the outer surface of the pane arranged to be wiped by wiper blades.

22. A vehicle glazing as claimed in claim 20, wherein at least one of the sensing lines further functions as an antenna and/or part of alarm circuitry.

23. A vehicle glazing as claimed in claim 20, wherein the pane of glazing material is provided with a heating element, and the sensing lines are located outboard of the heating element.

24. A vehicle glazing as claimed in claim 23, wherein the sensing lines are arranged on the inner surface of the pane of glazing material such that the capacitive moisture sensor is able to distinguish between moisture detected on each of the outer and the inner surfaces of the pane.

25. A vehicle glazing as claimed in claim 24, wherein the capacitive moisture sensor comprises activation electronics that is arranged to activate a) wiper blades when moisture is detected on the outer surface of the pane of glazing material, and/or b) the heating element when moisture is detected on the inner surface of the pane.

26. A vehicle glazing as claimed in claim 25, wherein the activation electronics is housed within a unit mounted relative to the inner surface of the pane of glazing material.

27. A vehicle glazing as claimed in claim 26, wherein the glazing is provided with an antenna and/or alarm circuitry, and the unit houses additional electronics which regulates their function.

28. A laminated vehicle glazing comprising:
two panes of glazing material having a ply of interlayer material therebetween;
at least one pane of the glazing material and/or the ply of interlayer material being body-tinted, thereby providing the glazing with a solar control and/or a privacy function, the glazing having an outermost surface and an innermost surface; and
a capacitive moisture sensor, comprising at least two separate sensing lines, mounted on the innermost surface of the glazing.

29. Use of a vehicle glazing as claimed in claim 16, as a backlight.

30. Use of a vehicle glazing as claimed in claim 16, as a rooflight.
